(19) United States
(12) Patent Application Publication
(10) Pub. No.: US 2017/0001332 A1
(43) Pub. Date: Jan. 5, 2017

(54) Multi Piece Mold Insert for Forming a Feature in Molded or Cast Concrete Structures

(71) Applicant: Theodore L. Kegeris, Fairland, IN (US)

(72) Inventor: Theodore L. Kegeris, Fairland, IN (US)

(21) Appl. No.: 15/199,731

(22) Filed: Jun. 30, 2016

Related U.S. Application Data
(60) Provisional application No. 62/186,958, filed on Jun. 30, 2015.
(60) Provisional application No. 62/324,199, filed on Apr. 18, 2016.

(51) Int. Cl. B28B 7/00; B28B 1/14

(52) U.S. Cl. CPC B28B 7/002; B28B 1/14

(57) ABSTRACT

A mold insert is disclosed for use in forming a structure cast in a form having a magnetic receptive portion. The mold insert includes a first mold insert member having a body portion and a first mating member. A second mold insert member includes a body portion and a second mating member. The first and second mating members are engageable to enable the first and second mold insert members to be configured in each of a joined configuration and an unjoined configuration. At least one magnet member is removably engageable to at least one of the first and second mold insert members. The magnet member, when engaged to the male insert member is configured for magnetically adhering to the form.

### PRIORITY STATEMENT

This non-provisional patent application claims benefit of priority to each of Kegeris, U.S. Provisional Patent Application No. 62/186,958 that was filed on 30 Jun. 2015, and Kegeris, U.S. Provisional Patent Application No. 62/324,199 that was filed on 18 Apr. 2016, both of which are fully incorporated herein by reference.

### I. TECHNICAL FIELD OF THE INVENTION

The present invention relates to structures that are cast in a form having magnetically receptive portions, such as cast or molded concrete structures, that are cast in steel forms, and more particularly to mold inserts that are used in conjunction with a magnetically receptive concrete form or mold, to incorporate desired features, such as an anchor member containing cavity into a cast concrete structure.

### II. BACKGROUND OF THE INVENTION

Typically, cast or molded concrete structures are manufactured by creating a form 4 (FIG. 2) that is similar to a mold. Flowable concrete is then poured in the mold 4 and allowed to harden. The walls of the form 4 are then removed from the exterior of the concrete structure after the concrete is hardened and the finished concrete structure is moved to its final location where it is used either alone or as a part of a larger structure such as a parking garage or other building.

Typically, the forms 4 are made of a metal material that can be removed from the concrete structure after it is formed. In casting concrete structures, there are often various features that are molded into the concrete structure. Decorative and chamfered mold inserts are often placed into the form to create a decorative surface for the concrete. Such items are the subject of other Theodore L. Kegeris patent applications that are hereby incorporated by reference, including Theodore L. Kegeris Utility patent application Ser. No. 14/807,318, filed 23 Jul. 2015, and Theodore L. Kegeris, Utility patent application Ser. No. 13/724,272 filed 21 Dec. 2012, all of which are hereby fully incorporated by reference including all of the related provisional applications.

There is often the need to mold a part into the concrete structure. One molded in part item that is often molded into a concrete structure is an anchor member 6, as shown in FIGS. 1 and 3. Anchor members 6 are typically molded into or formed as a part of the concrete structure so that a hook can be placed into the aperture formed by the anchor 6, to grab the anchor 6 so that one can then move the concrete structure using a material handling device such as a fork lift, crane, gantry or other such device.

In order to mold such an anchor 6 into the concrete structure, a cavity is typically formed in the structure. The type of concrete anchor that is typically molded into a structure is a U-shaped device 6 that has a first end with an anchor head 7, a second end with an anchor head 7, and a U-bent middle portion 8 that is curved to form a loop to which a hook may be attached.

In order to get the hook of the fork life or crane into the loop, the area surrounding the loop must be free of concrete so that an open space or hook-receiving aperture is formed. Additionally, as formed concrete structures are usually abutted end-to-end, it is usually important that the anchor member 6 not extend outwardly past the end surface of the formed concrete structure. Therefore, the loop must be placed in a cavity so that the anchor member is a recessed anchor member with a recessed loop.

Creating the recessed loop requires the presence of be a cavity that is devoid of concrete around the anchor member 6 so that the hook can extend into the cavity and engage the anchor member 6 near its middle portion 8. In order to form this cavity in the prior art, a plastic mold insert member 10 (FIG. 1) is coupled to the metal concrete form. The concrete is then poured into the form, and around the mold insert 10. After the form 4 is removed, the mold insert 10 is pulled out of the recess in the concrete structure. When so removed, a cavity remains that exposes the anchor 6 so that it may be engaged by a hook.

An example of such a mold insert 10 that has been employed by the Applicant to serve this purpose is shown in FIG. 1. As will be noted, the mold insert 10 has a shape that is similar to a bloated half-hockey puck (or aspirin pill) as it comprises essentially a disc that is thickened near its center. Like a typical aspirin tablet the thickness of the form member 10 tends to increase as one goes from the radially outward surface 12 of the pill along the diameter line of the pill to the center of the aspirin pill shaped mold insert.

A radially extending 11 cut that extends approximately two thirds of the way from the radially outwardly facing “edge” surface 12 of the mold insert 10, toward the diametrically extending form engaging surface 13. An enlarged diameter hook receiving passageway 14 extends in an axial direction, approximately halfway between the form engaging surface 13 and the radially, outwardly facing edge surface of the half-aspirin pill shaped mold insert 10.

The radially inwardly facing planar surface 13 of mold insert 10 includes a recessed cavity. The recessed cavity is designed for receiving a magnet member. A magnet member is fixedly coupled to the mold insert, and magnetically coupled to a surface of metal concrete mold form 4. This magnetic coupling helps to hold the mold insert 10 in place as concrete is being poured around it in the metal form 4. To attach the mold insert 10 to the anchor 6, the mold insert 10 is bent, so that it is split about the radially extending cut line 14.

In this regard, the portion 15 of the mold insert 10 between the radially inwardly facing surface and the beginning of the cut serves as something of a “living hinge” and allows the two halves of the mold insert to bend about the living hinge 15. To reinforce this hinge, one can use a reinforcing material such as fiberglass that is molded into the mold insert.

In operation, the anchor 6 is inserted into the axially extending aperture, by bending the mold insert 10 about the living hinge portion 15 to open up the aperture so that the anchor 6 may be inserted therein. After the anchor 6 is inserted, the mold insert 10 is magnetically coupled to the metal form 4 in its appropriate position. After being so coupled, the concrete is poured into the form 4 to form the concrete structure around the mold insert 10. The form 4 is then removed from the concrete structure which exposes the radially inwardly facing planar form engaging surface 13 of the mold insert 10.

Although the mold insert 10 is magnetically coupled to the form 4, the removal of the form 4 from the concrete structure may not remove the mold insert 10 with the form. Rather, the magnetic attraction between the mold insert 10 and the form may not be as great as the mechanical bond that exists between the mold insert 10 and the concrete that is molded around it. Therefore, to remove the mold insert 10, users typically insert a screwdriver into a space that is between the mold insert and the concrete and pry it out. Because the mold insert member 10 is flexible, one can pull out both “ends” of the mold insert 10, and in the process, cause the middle portion 15 of the mold insert 10 to bend about the living hinge 15 that helps to release the anchor 6. Once the mold insert 10 is pulled out of its concrete cavity, the anchor 6 is exposed so that a hook from a crane or other material handling device can be attached to the anchor so that the concrete form can be moved.

Although the above described device performs its function in a highly workmanlike manner, room for improvement exists. In particular, room for improvement exists in finding ways to make the mold insert member 10 in a more economical fashion and finding ways to increase the useful life of the product.

In particular, one of the most expensive components of the mold insert member 10 device is the magnetic member. It would be therefore helpful to provide a device that has a more easily removable magnetic member, so that magnetic members can be detached from failed or worn out devices and inserted into new devices, to thereby make the replacement costs for a mold less expensive.

Although the magnet member is generally the most expensive component of the mold insert 10 of the present invention, there are also costs involved in replacing the non-magnetic, plastic portion of the mold insert. In particular, the size and volume of plastic involved in the mold insert can contribute to the cost of replacing the mold insert if worn out or destroyed.

Therefore, another desirable feature would be to provide a device that helps to reduce replacement costs by making the mold insert from a plurality of joinable components, wherein individual components may be replaced without replacing the entire mold insert (even without the replacement of the magnetic member).

In a most preferred embodiment, the components of the mold insert would be designed so that those portions of the mold insert that are most prone to be worn out or damages were the portions of the mold insert were designed to be the lesser expensive component to replace, compared with other components of the multi-component mold insert.

Additionally, it is also an object of a preferred embodiment of the present invention to provide a mold insert that facilitates removal of the mold insert from the concrete member that is cast using the mold insert.

### III. SUMMARY OF THE PRESENT INVENTION

In accordance with the present invention, a mold insert is disclosed for use in forming a structure cast in a form having a magnetic receptive portion. The mold insert includes a first mold insert member having a body portion and a first mating member. A second mold insert member includes a body portion and a second mating member. The first and second mating members are engageable to enable the first and second mold insert members to be configured in each of a joined configuration and an unjoined configuration. At least one magnet member is removably engageable to at least one of the first and second mold insert members. The magnet member, when engaged to the male insert member is configured for magnetically adhering to the form.

In one embodiment, each of the first and second mold inserts includes one of a groove or a tongue (key). The coupler member includes one of a key (tongue), or groove for matingly engaging the corresponding key or groove of the mold insert member.

Preferably, the coupler member includes a pair of oppositely disposed, but generally co-linearly arranged male dove tail shaped tongue or key members, that are slidably insertable into an elongated dove tail shaped grooves that are formed on the first and second mold insert members.

One feature of the present invention is that the radially extending hook receiving aperture of the mold insert can be positioned adjacent to the radially inwardly facing surface of the mold insert members. By doing this, one can place the hook member closer to the end surface of the finished concrete structure, thereby facilitating the insertion of a moving hook into the loop formed by the anchor.

In an alternate embodiment, a mold insert is provided for use in forming a cavity in a structure cast in a form having a magnetically receptive portion. The mold insert comprises a first mold insert member and a second mold insert member. The first mold insert member includes a base portion, a base surface, a second insert receiving portion, a body portion extending outwardly from the base portion, and a magnet receiving cavity formed in the base portion. The second mold insert includes a first insert receiving portion for matingly engaging the second insert receiving portion of the first mold insert member. A magnet member is provided that is sized and configured for being received in the magnet receiving cavity. A first coupler is also provided that is accessible from the base surface for removably coupling the second insert member to the first insert member.

Preferably, the first and second member, when coupled define a central slot portion for receiving an anchor. The laterally extending finger extends across the slot between the first and second members, and is provided for forming an aperture adjacent to the anchor, to facilitate the engagement of a grabbing member, such as a hook, to the anchor to facilitate movement of the cast structure

One feature of the this alternate embodiment of the present invention is that the first and second members are separable from each other. This feature has the advantage of facilitating the removal of the mold insert from the concrete form that is used to mold the concrete form. Additionally, it helps to reduce the cost of replacing worn and damaged components of the insert member.

These and other features of the present invention will become apparent to those skilled in the art upon a review of the drawings and detailed description presented below.

### IV. BRIEF DESCRIPTION OF THE DRAWINGS

FIG. 1 is a perspective view of a prior art mold insert showing an anchor member coupled thereto;

FIG. 2 is a perspective view of a typical prior art metal form used for casting a concrete structure, with which the mold insert of the present invention is used;

FIG. 3 is a top view of an anchor member of the type that is molded into a concrete structure;

FIG. 4 is a top perspective view of the mold insert of the present invention showing the arcuate, semi-circular, radially outwardly facing edge surface of the mold insert;

FIG. 5 is an edge biased perspective view of the mold insert of the present invention, showing the first and second insert member being disassembled from each other, with a coupler member being coupled to the second mold insert, but not the first mold insert;

FIG. 6 is a bottom view of the form receiving surface of the mold insert, showing a magnet inserted into a first cavity formed in the planar form-receiving surface of the first insert member, but no magnet being inserted in the magnet receiving cavity of the second mold insert form engaging surface;

FIG. 7 is a side view of the first and second mold insert members being disassembled therefrom, without a coupler being attached to either of the first or second mold inserts;

FIG. 8 is a perspective view of the coupler member, showing its radially inwardly facing anchor receiving groove, along with its longitudinally extending tongue member that is insertable in the key engaging groove of the first and second insert member;

FIG. 9 is a side view of the coupling member showing the anchor receiving groove that is matable with the anchor receiving groove of the first and second insert members to provide an arcuate passageway for receiving the anchor member, and also showing the first and second keys or tongues that are receivable in the respective key engaging grooves of the first and second mold inserts, along with the arcuate radially inwardly facing anchor receiving groove;

FIG. 10 is a front face surface of the coupling member showing the first key member, and providing a different perspective view of the anchor receiving groove;

FIG. 11 is a perspective view showing an anchor member being received on the anchor-receiving groove of a coupler member coupled to one of the first and second mold inserts;

FIGS. 12-20 all relate to a first alternate embodiment mold insert of the present invention, wherein:

FIG. 12 is a side, exploded view of the multi-member first alternate embodiment mold insert of the present invention;

FIG. 13 is a top view of the mold insert;

FIG. 14 is an assembled, side view of the mold insert;

FIG. 15 is a side, disassembled view of the mold insert of the present invention, showing the bottom surface of the third mold member;

FIG. 16 is an exploded, top perspective view of the mold insert, showing the third mold member removed from its engagement with the first mold member;

FIG. 17 is a bottom view of the mold insert, showing one of the magnet members removed from its cavity, and also showing the fastener member, inserted in the fastener receiving aperture;

FIG. 18 is a top view of a magnet member and third mold member;

FIG. 19 is a bottom view of the third mold and magnet member; and

FIG. 20 is an end view showing the finger of the third mold member.

### V. DETAILED DESCRIPTION

The description that follows describes, illustrates and exemplifies one or more particular embodiments of the present invention in accordance with its principles. This description is not provided to limit the invention to the embodiment or embodiments described herein, but rather to explain and teach the principles of the invention in such a way to enable one of ordinary skill in the art to understand these principles and, with that understanding, be able to apply them to practice not only the embodiment or embodiments described herein, but also other embodiments that may come to mind in accordance with these principles.

The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing reference numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Furthermore, certain views are side views which depict only one side of the device (or one set of components of a multi set array of components), but it will be understood that the opposite side and other component sets are preferably identical thereto. The present specification is intended to be taken as a whole and interpreted in accordance with the principles of the present invention as taught herein and understood by one of ordinary skill in the art.

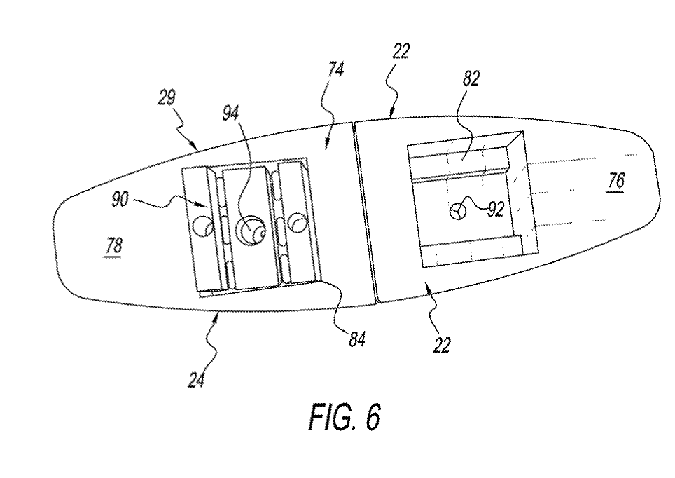

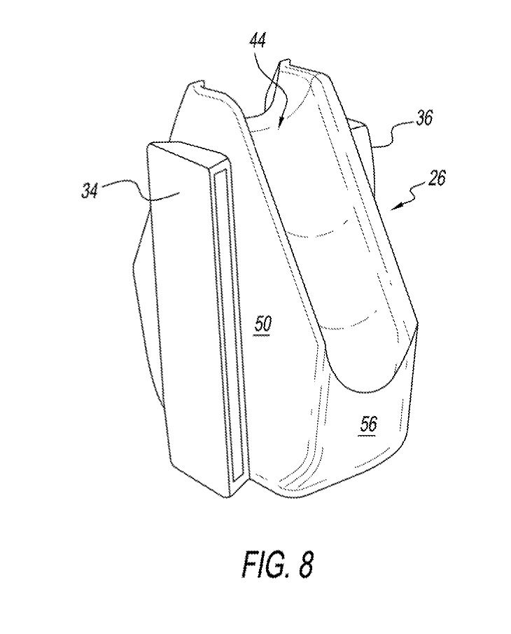

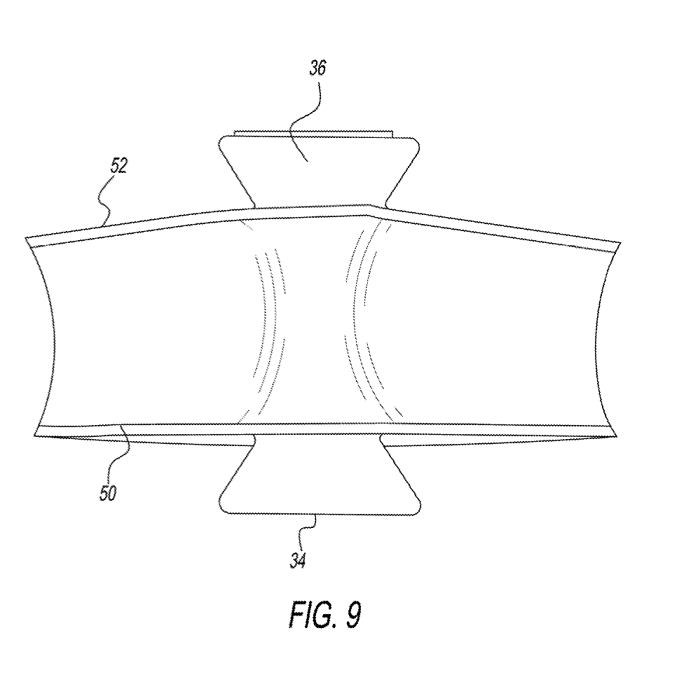

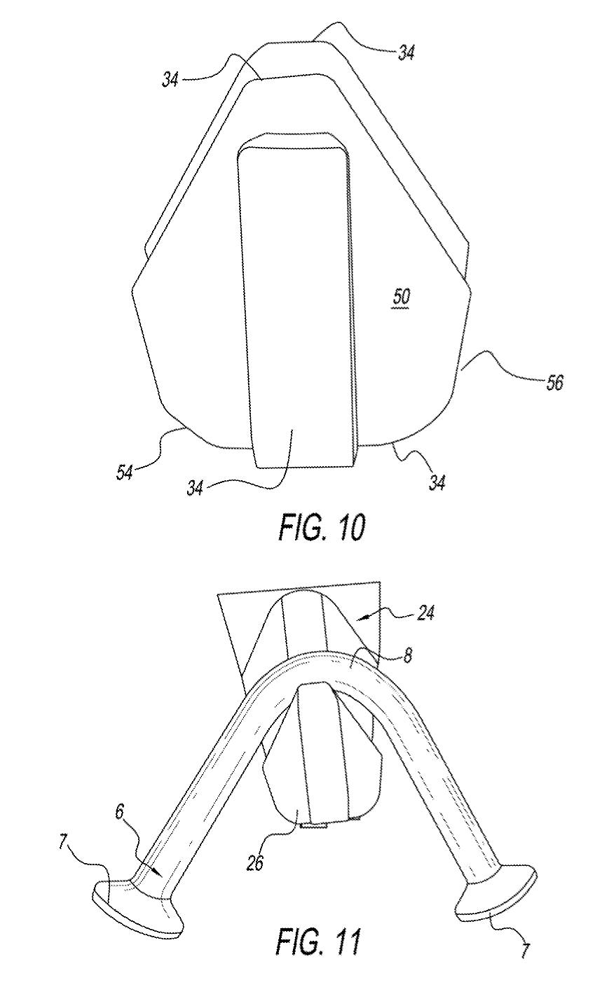

A first embodiment mold insert 20 of the present invention is shown in FIGS. 4-11 that is placeable into a form having magnetically receptive portions, such as steel form 4 for making a cast concrete structure component that is used either by itself or in conjunction with other components (including possibly other cast concrete components) to form a composite structure such as a stadium, bridge, parking garage or other structure. Examples of uses of cast concrete structures can be found at www.constructor.org. It should also be noted that cast concrete structures are often referred to as “pre-cast” concrete structures, since the casting often takes place at a location other than the final resting place of the structure.

The mold insert 20 includes a first mold insert member portion 22, a second mold insert member portion 24, and a third coupler member portion 26 that is provided for removably coupling the first mold insert portion 22 to the second mold insert portion 24.

Each of the first and second mold insert portions 22, 24 includes one member of a mating pair comprising a first mating member and a second mating member. In a preferred embodiment, the mating pair comprises a first, elongated key mating member, and a second, elongated groove mating member that is sized and configured for slidably receiving the first, elongated key shaped mating member. One of the key and groove is affixed to, or formed as a part of the coupler member 26, and the other of the key and groove are affixed to, or formed as a part of the first and second insert member portions 22, 24.

In the present embodiment, both of the first and second insert member portions 22, 24 have grooves 30, 32 formed thereon so that they can be made to be identical, and therefore interchangeable. It will be appreciated that the first insert member portion 22 could be designed with a groove 30 to receive a key of the coupler member 26, and that the second insert member portion 24 can be designed to have a key that is sized and configured for being slidably received by a groove formed in the coupler member 26.

Preferably, the coupler member 26 includes a pair of oppositely disposed, but generally co-linearly arranged dove tail shaped key members, that are slidably insertable into an elongated dove tail shaped grooves 30, 32 that are formed on the first and second mold insert members portions 22, 24.

A radially extending aperture 38 having a U-shape extends laterally between the first insert member portion 22, second insert member portion 24 and anchor the coupler member portion 26 that is sized and configured for receiving the U-shaped bend in the middle portion 8 of coupler 6. The radially joined aperture 38 is generally “U-shaped” to receive the U-shaped middle portion of the anchor. However, it will be appreciated that in molded in parts such as anchors 6 having shapes other than U-shapes, that a different shape will be provided.

One feature of the present invention is that the radially extending anchor 6 receiving aperture 38 can be positioned adjacent to the radially inwardly facing surface of the mold insert members 22, 24. By doing this, you place the anchor member 6 is positioned closer to the end surface of the finished cast concrete structure and component which thereby makes it easier to insert a hook into the loop of the anchor member 6.

The insert member coupler portion 26 includes a radially outwardly facing surface 42 and a radially inwardly facing surface 46. The radially outwardly facing surface 42 of the mold insert coupler member 26 has a shape that is generally consistent with the shape of the mold insert 20 radially outwardly facing surface 48 so that when the first 22 and second 24 mold insert members are coupled together with the coupler 26, a continuous, radially, outwardly facing arcuate surface 48 is provided.

Additionally, the first 54 and second 56 outwardly facing exposed side surfaces of the coupler member 26 are also sized and configured to mate up with and match with the concrete engaging side surfaces of the first and second mold insert members 22, 24. However, radially inwardly facing surface 44 of the coupler however is U-shaped or V-shaped, so as to receive the surface of the middle portion 8 of the anchor member 6, and to align generally with the curvature of the anchor member 6.

As discussed above, a pair of elongated dove tail shaped, constant cross-sectioned male mating members are provided on the coupler member 21. The male dove tail shaped tongue or key members 34, 36 are disposed on opposite sides of the coupler member 26, and are positioned so as to be received by appropriate female dove tail shaped grooves 30, 32 of the first 22 and second 24 mold insert member portions. The male elongated dovetail members 34, 36 are preferably designed for easy molding, such that a two part injection mold (not shown) in which the mold insert coupler portion 26 is made, can come together and de-couple without interference.

When the coupler member 26 male mating member 34, 36 is inserted into the female dovetail groove mating member 30, 32, at its appropriate position, a U-shaped aperture 38 will be formed that extends generally radially in the mold insert member 20. This U-shaped aperture 38 will be designed so that the anchor member 8 can fit appropriately therein. It will be appreciated that as the radial aperture 50 of the mold insert 20 is designed to receive an anchor 6, the shape of the aperture will differ if a different shaped anchor 6 is employed.

The radius of this curve of the anchor receiving groove 44 should be sized and configured for snugly receiving the middle portion 8 of the anchor 6 when the mold insert 20 is assembled, and the anchor 6 is received in the radially extending aperture 38. The anchor receiving groove is semi-circular in cross-section to help better position and secure the anchor 6 in the mold insert 20.

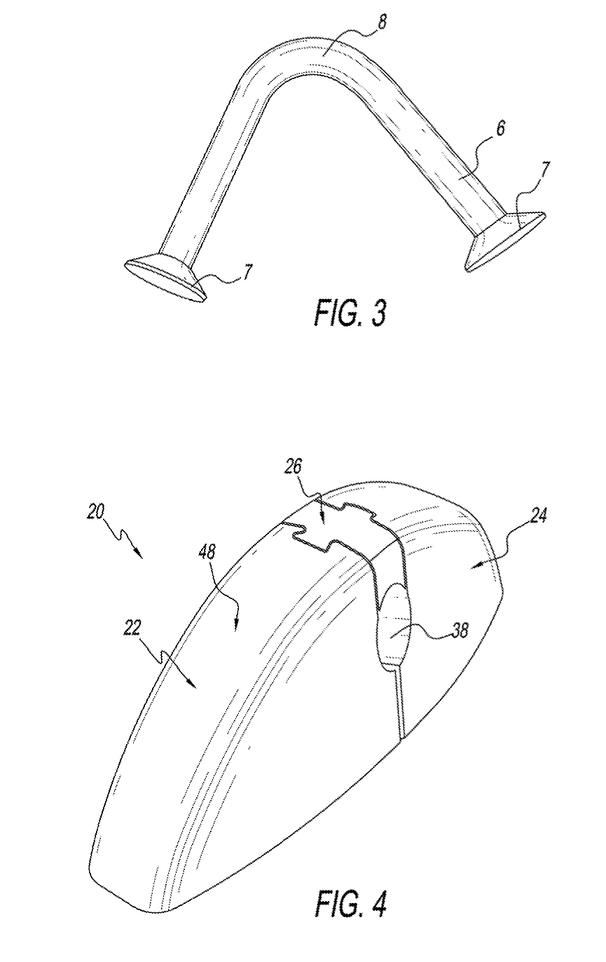

Your attention is now directed to the first 22 and second 24 mold insert members shown in FIGS. 3-11.

The first and second mold insert members 22, 24 are designed to be generally identical in size, shape and configuration. By making these two 22, 24 to be identical, several advantages are achieved. The first advantage is that the mold insert portions 22, 24 can be used interchangeably. As such, one does not need to mate right with left because all of them will mate together. In use in the field, this makes life much easier for the user because one need not waste matching appropriate “first” to “second” mold insert member portions together, since any way the mold insert portions will mate together.

Further, this identicality reduces inventory and storage difficulties because one can store first and second members 22, 24 together in a common inventory bin, rather than having to provide separate “right and left” insert member bins. Third, the identicality makes ordering much more easy, because the user will not encounter a situation where she thinks she has enough members, only to find out that for example that the existence of 40, a hypothetical insert member portions will form only 6 assembled mold inserts, since 34 and 30 are right handed members but only 6 are left handed members. Rather, with the identical first 20 and second 22 members, one can just look at the gross number of insert members and when the supply of members becomes low, just order a replacement number of members to fill one's needs. Also, the 40 hypothetical insert member portions can be counted on to yield 20 complete mold insert members, so long as one also has at least 20 coupler member 26.

Turning now to the mold insert members 24, it will be noted that the outer surfaces of the assembled mold insert members 20 are not that significantly different in shape from the prior art in shape mold insert 10. In particular, when fully assembled, the mold insert device 20 has the shape of one half of an aspirin pill or hockey puck, wherein the thickness of the pill is greater near the radially inwardly surface 74 than it is at the radially outward edge surface.

One significant difference between the prior art mold insert 10 and the mold insert 20 of the present invention is that since mold insert 20 employs sliding parts that inter-engage, it is preferred that mold insert 20 be formed out of a harder, thicker, plastic and preferably one with some lubricity or a slick surface so as to promote the sliding movement of the male dovetail mating members 34, 36 within the female dovetail mating grooves 30, 32. If one uses a softer, stickier, rubber-like material, engagement and disengagement of the male and female members 34, 35, 30, 32 would be frictionally impeded.

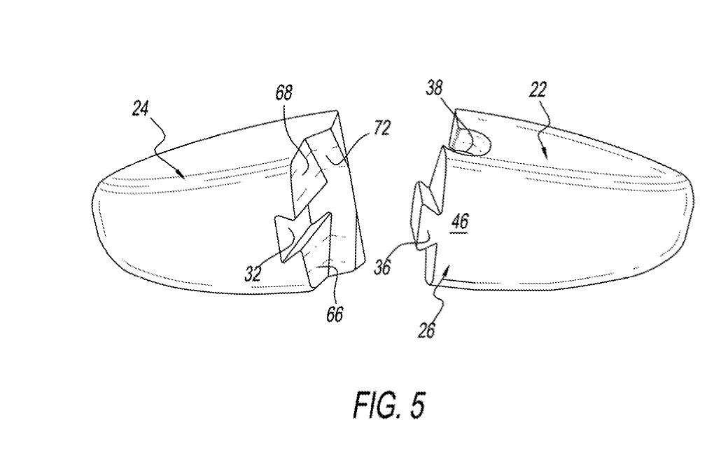

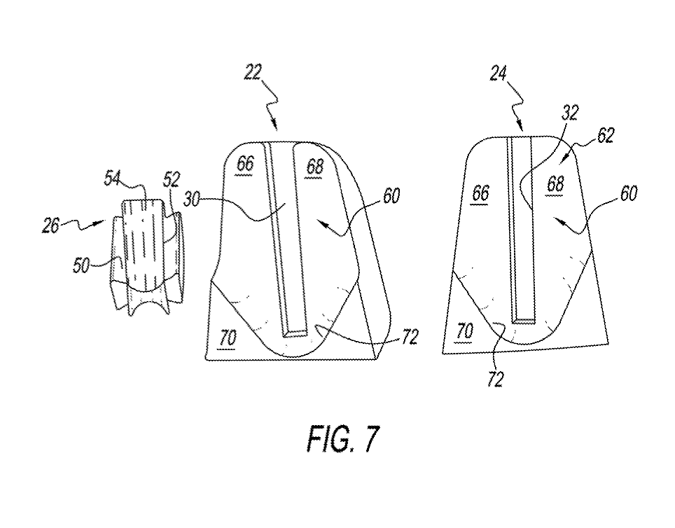

Unlike the prior art, the mold insert 20 of the present invention has first, second and third mold insert member portions 20, 22, 26 that are fully dis-assembled and fully removable from each other. As best shown in FIGS. 5 and 7, each of the first 22 and second 24 mold insert member portions has a radially extending mating surface 60, 62. The first 60 and second 62 radially extending mating surfaces are preferably identical and each includes a radially outwardly disposed, first planar portion 66 and a radially outwardly disposed second planar portion 68. The first 66 and second 68 radially outwardly planar portions are bisected by a female dovetail shaped mating groove 30, 32 that is provided for receiving the dovetail shaped male mating member 34, 36 of the coupler member 26.

The radially inwardly disposed portion 70 of the mating surface is raised from the radially outwardly disposed planar surface, so that when the mating members are assembled, there exists a spacing between the radially outwardly disposed mating portions 66, 70, of the mating surfaces 60, 62 of the first and second mold insert members 22, 24, although the radially inwardly disposed portion 70 of the mating surfaces 60, 62 of the first and second mold insert members 22, 24 can abut each other, which is the preferred configuration. A U-shaped shelf member 72 is provided for receiving the outwardly facing surface of the middle portion 8 of the anchor member 6.

The space between the first and second mold insert members 20, 22 is at least partially occupied by the coupler member 26 when the first and second mold insert members 22, 24 are joined.

The coupler member 26 not only joins the two mold insert members 22, 24 but places them together at the appropriate spaced relationship. It is important that the mating surfaces 60, 62 of the mold insert member portions 22, 24, 26 abut and join, because by abutting and joining, they do not allow concrete to flow there through which helps to aid in the removal of the device from the concrete structure, once the concrete structure is formed.

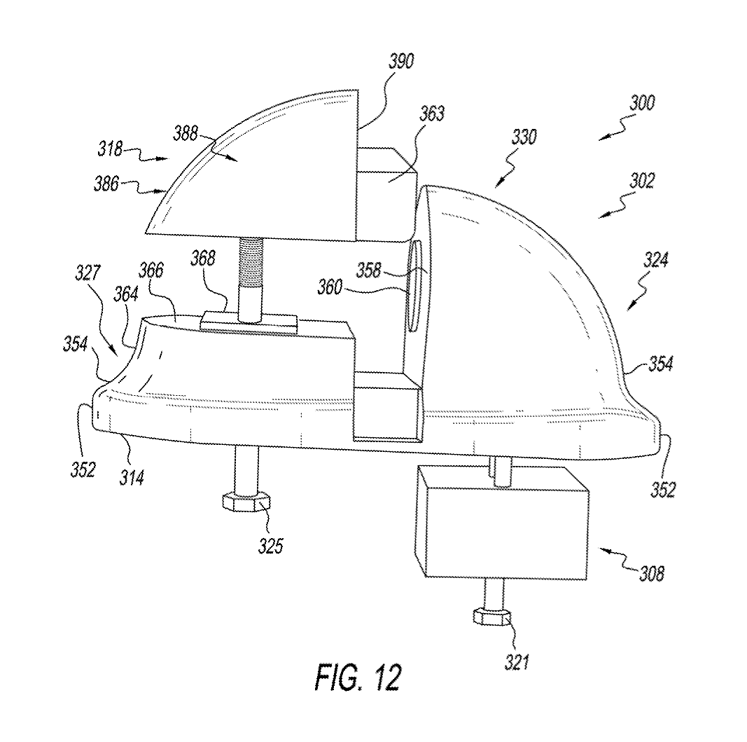

The mold member 20 includes a planar form engaging surface that is comprised of the cavity containing first mold insert portion 22 form engaging surface 76 and second mold insert 24 planar form engaging surface 78. Each of the form engaging surfaces 76, 78 includes a magnet receiving cavity including a first magnet receiving cavity 82 and second receiving cavity 84 for receiving first (not shown) and second 90 magnet members, respectively. Although first magnet is not shown, it is identical to second magnet 84, and may also be identical to magnet 308 of FIG. 12.

It will be noted from the drawings that the outward edge of the anchor 6 should be very closely spaced to the form engaging surfaces 74 of the mold insert member 20. In the preferred embodiment, this spacing can be a fraction of an inch, certainly less than 0.5 inch, and most preferably between about 0.25 and 0.09375 inches. By placing the anchor member 6 close to the form engaging surface 76 of the finished concrete form, one places the anchor 6 in a position where it can be more easily grabbed by a hook member, as one does not have to insert the anchor deeply into in the recessed cavity dished out area as far as one would with the prior art. This spacing maintains the outer edge of the anchor 6 within close proximity of the side surface of the finished concrete form.

The planar form engaging surface 76, 78 of each mold insert member portion 22, 24 includes a dished out cavity 82, 84 that, in the preferred embodiment is a rectangularly cuboid shaped cavity that may include one or more rounded corners for facilitating the placement of the magnet members (not shown) go in a proper orientation. The cavity area comprises a magnet receiving cavity 84 that is formed for receiving the magnetic circuit member (not shown, 90).

It will be noted that an aperture 92 exists within the interior of the magnetic circuit receiving cavity 82. This aperture 92 is provided to enable one to insert a retaining screw through a central aperture 94 of the magnetic circuit 90 to removably fasten the magnetic circuit member 90 into the cavity 84 of mold insert member portion 24 to fixedly couple them together, so that when one pulls the mold insert 20 out of the finished concrete structure, the magnetic member (not shown) 90 comes with it.

The magnetic member (not shown) 90 can be inserted into the cavity 82, 84, as shown in the figures. The magnetic circuit 90 that is employed is similar to one that is described in other Kegeris patents (above) that discuss the improvement to the magnetic circuit that has a greater magnetic capacity than those known in the prior art.

It will be appreciated that there are essentially five components of the current system. These five components include a first mold insert half 22, a second mold insert half 24, and coupler 26, all of which are preferably made from a plastic material.

A fourth component is the first magnetic circuit (not shown) and the fifth component is the second magnetic circuit 90. Of these parts, the least expensive part to produce is the coupler member 26. The second least expensive parts to produce are the mold insert members 22, 24. The most expensive parts to produce are the magnetic members (not shown) 90. It is believed for example that a single magnetic member 90 could easily be thirty or forty times as expensive as the cost of a single mold insert member 22, 24. Therefore, from a practical standpoint, the destruction of a mold insert member 22, 24 is not as financially bothersome as the loss of a magnetic member 90.

The present mold insert 20 is designed to help reduce replacement costs, by configuring the device 20 in a manner wherein the least expensive parts 22, 24, 26 are the ones that are the most likely to be worn out or reused, and so that the more expensive parts (the magnetic members 84) are positioned and designed so that they can be easily recovered from an otherwise damaged mold 20 and reused in later devices.

It is envisioned that the coupler member 26 is the part that is most likely to be worn out on a regular basis. The Applicant believes that it is likely that a typical user will damage or destroy several coupler members before one wears out a mold insert member 22, 24. Although one would like a coupler member 26 to last forever, the wearing out of the coupler member 26 is not a significant financial hardship because it is the least expensive part of the mold insert 20 to replace. As such, replacing a coupler 26 does not add that much to the cost of the final forms produced even if one were to have to use all new coupler members 26 with every form produced.

Because of the design of the coupler 26 and insert 20, one can simply get another coupler member out of the supply bin if the coupler member 26 does break and attach it to the two existing and still functioning mold insert members 22, 24.

It is believed that the mold insert members 22, 24 will likely to have a long life. However, due to the rough nature of the treatment in the mold insert 20 will undergo in a concrete forming operation, it is likely that they 22, 24 will become damaged over time. For example, it is envisioned that mold insert members 22, 24 may adhere to the finished concrete product, and that employees will try to remove them by prying them out with levers such as screw drivers, pushing them out and otherwise dinging them and denting them and cracking them to the point where 22, 24 may break.

When a mold insert member portion 22, 24 wears out, they can be replaced quite easily and efficiently. First, the first 22 and second 24 mold insert members are preferably designed to be identical members 22, 24 and are freely interchangeable. As such, if one damages the “second” half mold insert member, one can always use the first member 22 to mate with the remaining mold insert member 24. Therefore, one only destroys half the device 20 and not the entire device 20. Also, the cost of replacement for a mold insert member portion 22, 24 is not that expensive relative to the cost of the concrete structure products.

The most important component from a cost perspective is the magnetic circuit 90. Because the magnetic circuit 90 is made from a metal material, it should be useable for a very long time, and will probably only need to be replaced when either the threads of aperture 94 are worn out internally, or the device 84 is lost or otherwise stolen. The magnetic circuit 90 should be designed to fit in the cavity, and to be easily removed.

A threaded screw member (not shown) can fasten the magnetic circuit 90 into the cavity 84 to maintain the magnet within the mold insert cavity 84. However, the magnet member 90 can be removed by unscrewing the screw and pulling the magnet member 90 out of the cavity 84. Additionally, since the magnet member 90 is likely to be removed from the cavity 84 when the device 20 is destroyed, one can pry the magnet 90 out, pull the magnet 90 out, or grab the magnet 90 out by destroying the mold insert members 22, 24, 26, as damaged mold insert members 22, 24, 26 are probably useless and inexpensive to replace.

It is believed that the mold insert members 22, 24, 26 will be made in a manner so that a nut is either cast or insert molded into the plastic so that the nut can threadedly receive the bolt member in the threaded aperture 94 in the magnet receiving cavity 84.

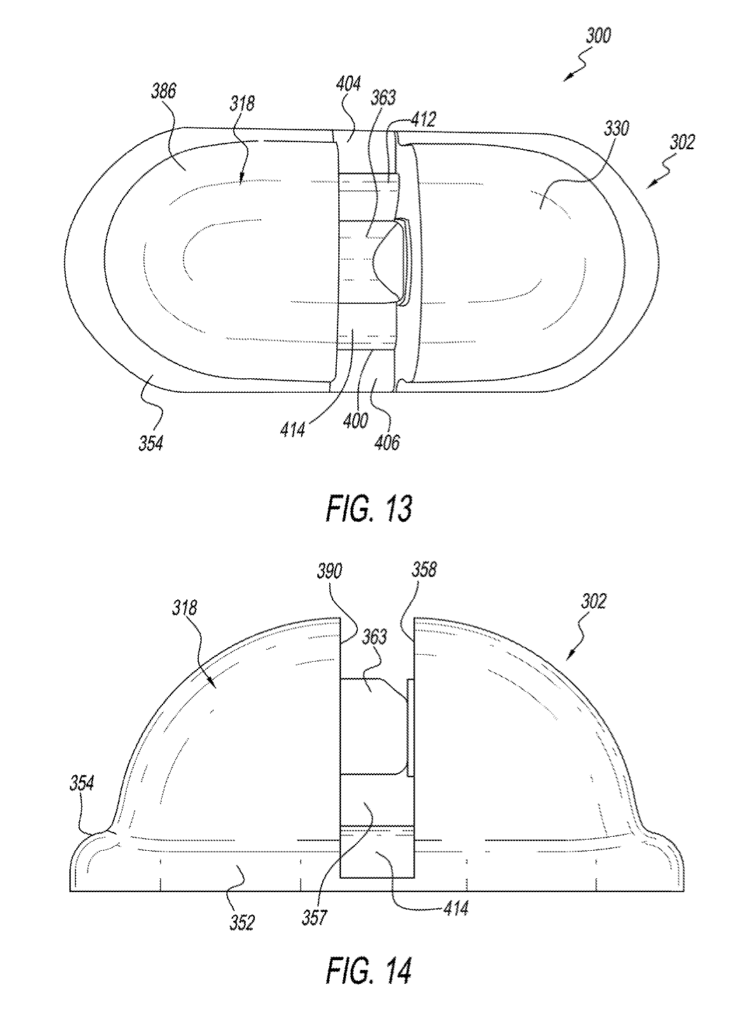

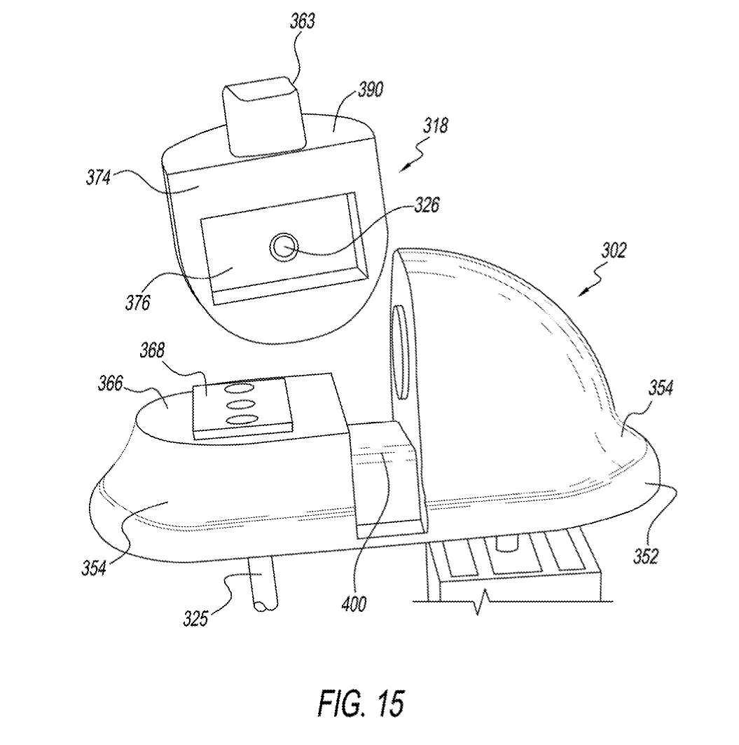

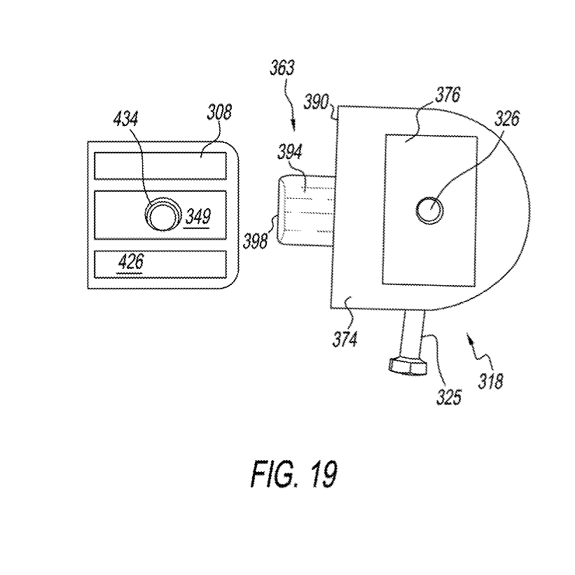

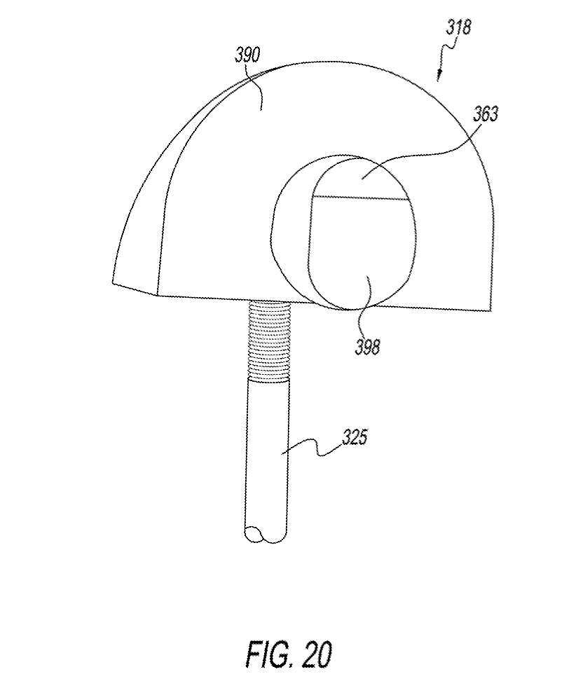

A first alternate embodiment mold insert of the present invention is shown in FIGS. 12-20.

The mold insert 300 of the first alternate embodiment of the present invention comprises a multi-component mold insert 300 that includes a first mold insert member 302 that comprises the bulk of the unit. A pair of magnet circuit containing second mold members (also known as magnetic circuit members 308, 310) are engageable with the first mold insert member 302, through insertion into a first and second cavities formed in the first mold member 302 in the first bottom surface 314 of the first mold insert member 302. A third mold insert member 318 is selectively attachable to the first mold insert member 302, and, with the first mold member 302, forms the primary shape of the mold insert 300, that forms the anchor containing cavity that is ultimately molded into the concrete component in the form 4 (not shown).

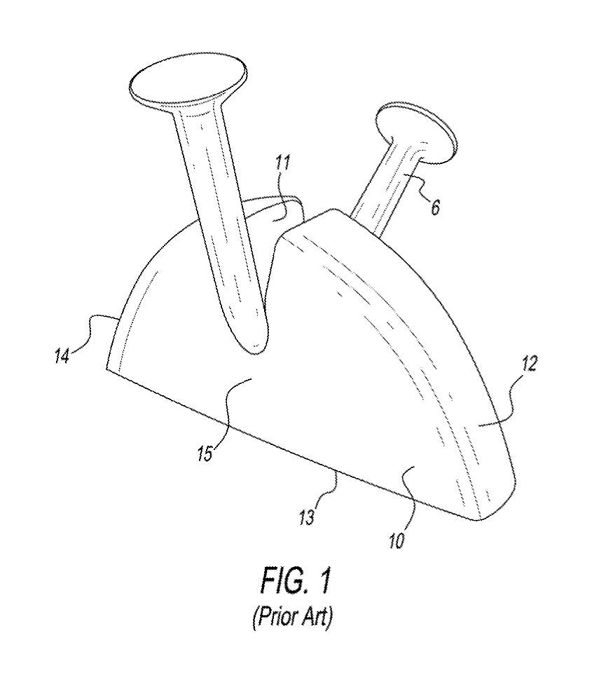

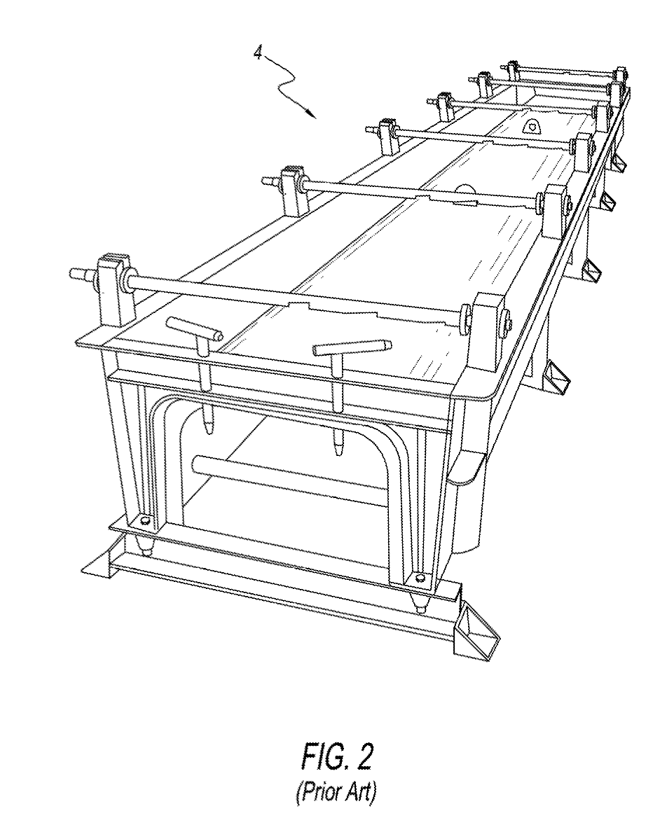

One of the features of the first alternate embodiment magnet insert 300 is that it includes removable first and second magnet circuit members 308, 310. The removable first 308 and second 310 magnet members employ a magnetic circuit that is similar or identical to the magnet circuit shown in the first embodiment mold insert (FIGS. 4-1).

The removability of the first and second magnet circuit members 308, 310 is an advantageous feature because it contributes to the overall cost containment of the use of the mold inserts 300. It has been found by the Applicant that of the three mold insert members, the magnet members 308 and 310 are generally the most expensive and are much more expensive to produce the either the first 302 or third 318 mold insert member.

Additionally, the magnet members 308, 310, as formed in the first alternate embodiment are likely to be durable, long-lasting members 308, 310. The magnet members 308, 310 are durable and long-lasting both because of the metal that comprises the majority of the magnet member, and also because of their positioning within the mold insert 300.

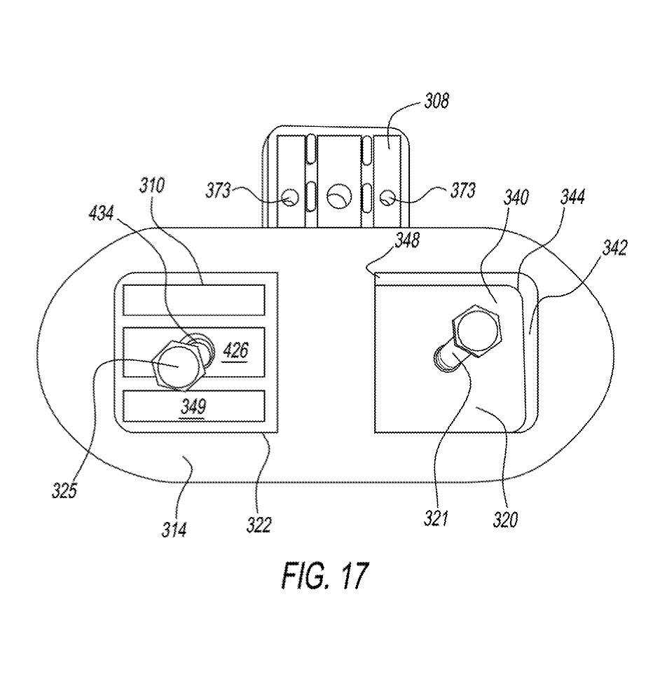

The magnet members 308, 310 are recessed within a pair of interior cavities including first magnet receiving cavity 320 and second magnet receiving cavity 322. The cavities 320, 322 are formed in the planar bottom surface 314 of the first mold insert 302. In FIG. 17, the general position of second cavity 322 is shown. However, the actual second cavity 322 is not shown, since it has been filled by receiving second magnet circuit member 310. This interiorly received position wherein only the surfaces of the magnet circuit members 308, 310 are exposed to the exterior of the insert 300, helps to protect the magnets 308, 310 from becoming deformed, chipped, broken or otherwise rendered unusable.

Additionally, as the first and second magnet members 308, 310 comprise both metal and plastic portions; the metal portions of the magnet members 308, 310 serve not only to provide the magnetic force for the device 300, but also a reinforcer for the plastic. The metal of the magnets reinforces the shape of the magnet members 308, 310, thus rendering the magnet members less susceptible to distortion, bending or deformation. Additionally, as the magnet members 308, 310 include only a relatively small quantity of plastic, the plastic, if broken or deformed, can be removed, such as by heating, melting or physical removal from the metal component of the members 308, 310. The metal portions of the magnets can then be re-insert molded with new plastic added to the metal members to form a new mold insert magnet member 308, 310 that includes the original metal magnet portion that is clad and housed in with newly applied plastic.

Another advantage of the first alternate embodiment mold insert 300 is that the third mold insert member 318 is the least expensive component of the device 300 to produce. The third mold member 318 is also the portion of the device 300 that is most likely to become broken or deformed during use. As such, of the separable components (302, 308, 310, 318) of the mold insert 300, the third mold member 318 is the component that is most likely to be replaced on a frequent basis. By making the most replaceable member in a configuration that enables it 318 to be manufactured as the least expensive member, one also helps to reduce the long-term cost of operation of the use of the mold insert 300.

The magnet circuit members 308, 310 are likely to be the longest lasting member of the unit 300 because of their shape and interior positioning. The first mold member 302 is likely to be the second longest lasting member of the insert 300. Thus, during the useful life of a device 300, the three components can be replaced as needed, with the least expensive part (the third mold member 318) designed to be the most frequently replaced, and the most expensive component (the magnet circuit containing members 308, 310) designed to be least frequently replaced.

The third mold member 318 is believed to be the part that is most likely to wear out, because of the type of abuse that the third mold member 318 is likely to encounter during use. When the mold insert 300 is used to manufacture cast concrete structures and structural components such as slabs, pre-cast flooring and walls, etc., one of the latter steps in the molding or casting process is to remove the mold insert 300 from the concrete article so produced.

If it were not for the existence of the laterally extending, aperture forming finger 363, this removal could occur through the magnetic interaction of the mold insert 300 magnet circuit members 308, 310 and of the metal surface of the metal form 4 that comprises the mold into which the concrete is poured to give the concrete component its shape. The magnetic attraction between the magnetic circuits 308, 310 of mold insert 300 and the form 4 would cause the form 4 to pull the mold insert 300 out of its cavity within the concrete article.

However, to remove the mold insert 300 from its engagement with the cavity within the concrete article, it is necessary to separate the third mold member 318 from the first mold member 302. This separation is necessary because the radially extending finger 363 of the third mold member 318 will not be easily removed from the cavity because it will be mechanically held in the cavity since the finger 320 is buried within the aperture of the anchor member 6 molded into the cavity. Therefore, it is likely that one will need to pry the third mold member 318 out of the concrete cavity.

Such prying is typically performed by either inserting a fastener 325 into the threaded aperture 326 of the third mold member 318 and pulling it out, or alternately, by using a screwdriver that is inserted between the radially outwardly facing surface 330 of the third mold member 318 and the adjacent concrete article, and then using the screw driver-like object to serve as either a lever or chisel to separate the third mold member 318 from its engagement with the concrete article poured around it.

This constant prying will probably adversely affect the surface 330 of the third mold member 318, and may cause the third mold member 318 to break and degrade over time, thus necessitating replacement. Once such replacement is necessary, the replacement can be made relatively inexpensively, since the third mold member 318 is the least expensive component of the device 300.

The first alternate embodiment mold insert 300 that is shown in the drawings includes a first end 324 and a second end 327. The first end 324 includes a fixed, unitary domed portion, and a second end 327 includes a removable domed portion, in the form of the third mold member 318.

The first end 324 of the mold insert 300 includes a radially outwardly facing dome surface 330, that defines the shape of the cavity that is formed in the molded concrete component member. The first member 302 includes a generally planar bottom surface 314 that includes a first cavity 320 into which the first magnet member 308 is received, and a second cavity 322 into which the second magnet member 310 is received.

The first and second cavities 320, 322 are preferably formed identically, but configured as mirror images of each other. However, the first and second magnet circuit members 308, 310 are preferably identical in shape and configuration, and are designed to fit in either of the first or second cavities 320, 322.

One cannot see the second cavity 332 in the figures, as the second magnet member 310 is inserted therein. However, FIG. 17 shows the opened, first cavity 320, with the magnet member 308 removed therefrom. The first cavity 320 includes a generally planar bottom surface 340, that is surrounded by perpendicularly disposed side walls 342. The side walls 342 have a pair of rounded corners 344, and a pair of square corners 348. The use of the different types of corners (square and rounded) helps to ensure that the magnet members 308, 310 are oriented properly within the cavities 320, 322 so that the magnets extend in the appropriate direction, so that the field generated by the magnetic circuits is the field desired by the Applicant.

The height of the side walls 342 is such that when one of the magnet members 308, 310 is inserted within the cavity 320 or 322, the upper, outwardly facing surface 349 of the first or second magnet member 308, 310 is designed to be co-planar, or flush with the generally planar bottom surface 314 of the first mold member 302.

The side of the first mold member 302 includes a relatively enlarged base portion 352. The base portion 352 generally has walls that are disposed in a plane that is perpendicular to the plane of the bottom surface 314. As the mold insert 300 is ultimately designed to define a cavity within a concrete article, and as the mold insert 300 must be removed from the cavity, it is most helpful to design the exterior surface of the mold insert 300, so that the portion that is disposed adjacent to the mold form 4, and that therefore defines the outer surface of the cavity, which here is the base portion 352, has a larger cross-sectional area than the remainder of the mold insert 300.

Additionally, the cross-sectional area of the mold insert 300 should be designed to decrease, as one moves from the bottom surface 314, that comprises the outer surface of the cavity to the top of the domed portion 330 that comprises the inward most portion of the cavity formed in the concrete article. If one were to design the mold insert device 300 so that the inner portion had a greater cross-sectional area than the outer portion, it would be difficult to remove the mold insert 300 from the cavity formed in the concrete article.

The domed portion 356 is generally disc or pill shaped having a rounded arcuate radially, outwardly facing surface. A radially inwardly facing generally planar surface 358 is formed at the radially inner terminus of the domed portion 356 of the first member 324. The radially inwardly facing planar surface 358 helps to define the centrally disposed anchor receiving slot 357 that is formed between the radially inwardly facing surfaces of the first 302 and third 318 mold insert members. The radially inwardly facing surface 358 includes a raised stage 360 that is preferably disposed adjacent to and in an opposed relation with the laterally extending finger 363.

It will also be noted that a beveled surface 354 extends between the radially outwardly facing surface 330, and the base portion 352, to serve as a transition there-between. The beveled portion 354 is disposed generally in a plane that is disposed obliquely to both the base portion 352 and the domed surface 330 at the intersections thereof. At the second end 327 of the first mold member 302, it will be noted that the base portion 352 and beveled surface 354 are continued generally from the first end 324.

At the upper terminus of the beveled portion 354 is a domed riser portion 364. The domed riser portion 364 is generally disposed in a plane that is perpendicular to the bottom surface 314. The domed riser portion 364 includes a perpendicularly disposed dome stage 366 having a raised portion 368. The domed stage 366 and raised portion 388 are sized and configured for receiving the generally planar, underside surface 374 and recessed portion 376 of the third mold member 318. The recessed portion 376 is sized and configured for receiving the raised portion 368. Additionally, the planar bottom surface 374 is sized to have an area and a shape that is generally equal to the area and shape of the dome stage 366.

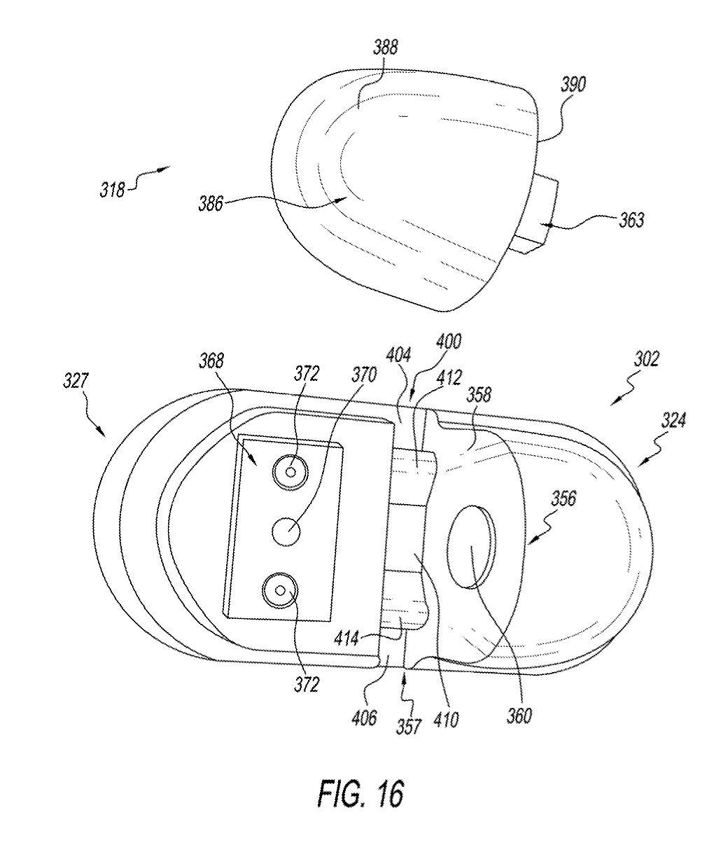

As best shown in FIG. 16, the raised portion 368 includes a central aperture 370 that extends between the raised portion 368 and the underside surface 314. A pair of fasteners such as allen bolts 372 extend through the raised portion 368, and are aligned with apertures (not shown) in the magnet member 310 so that the allen bolts 372 can securely fasten the magnet member 310 in the second cavity 322, to maintain the magnet member 310 in the second cavity 322.

Maintaining the second magnet member 310 in the second cavity 322, and providing a mechanical fixing mechanism therefor is most useful when separating the concrete article from the insert member 300, for without such mechanical fixation, there is a reasonable likelihood that the magnetic attraction between the metal concrete form 4 and the magnet member 310, would cause the magnet member 310 to be pulled out of the second cavity 336 and thereby become separated from the first mold member 300.

The third member 318 includes a domed portion 386 having a radially outwardly facing surface 388. The radially outwardly facing surface 388 is designed and configured to generally compliment the radially outwardly facing surface 330 of the first end 324 and first insert member 302, so that the combined mold insert 300 therefor creates a symmetric cavity, with symmetry between the first and second halves of the cavity so formed.

The third mold insert member 318 includes a radially inwardly facing surface 390, out of which extends a laterally extending cylindrical finger 363. The radially inwardly facing surface 390 defines one side wall of the centrally disposed anchor receiving slot or cavity 357.

The laterally extending cylindrical finger 363 has a cylindrical side wall surface 394, and a generally planar end surface 398. The cylindrical finger 363 is sized so that the planar end surface 398 matingly engages and is placed against the raised surface 360 of the radially inwardly facing surface 358 of the first dome member 330. As such, the laterally extending finger 363 extends across the anchor receiving cavity 357 formed by the space between the radially inwardly facing surfaces 358, 390.

As discussed above, and is best shown in FIGS. 12 and 14, the radially inwardly facing surfaces 358, 390 are disposed in a generally parallel spaced relation to form a cavity 357 there-between.

A cradle portion 400 is formed at the bottom of the cavity 357, on an upper surface of the first mold member 302. The cradle portion 400 is formed from recessed outer portions 404, 406, and a centrally disposed recessed arcuate portion 410 that is disposed between a pair of opposed raised ends 412, 414. The cradle 400 is sized and configured to receive the curved middle portion 8 of an anchor 6 that is to be inserted in the concrete. The finger 363, cradle 400 and walls 358, 390 are cooperatively sized, shaped and configured to hold the anchor 6 in place when the concrete is being poured in the form 4 to create the concrete article.

The first and second magnet circuits members 308, 310 are generally similar. In essence, the magnet circuits 308, 310 are each comprised of a magnetic circuit 420 that is encased within a plastic housing 422. Preferably, the magnetic circuit 420 comprises a plurality of metal members that are formed with the plastic housing 422 being molded around the appropriately positioned magnetic metal members 420. The magnetic circuit members 308, 310 include a generally planar exterior surface 426 and generally planar interior surface 428. Additionally, each of the magnetic members 308, 310 includes four sidewall portion 432 that are disposed in a plane generally perpendicular to the interior 428 and exterior 426 surfaces. The sidewall portions 432 are provided for matingly engaging the sidewalls 342 of the respective cavity into which the magnet circuit 308, 310 is to be inserted, such as cavities 334, 336.

It will be noted that the interior surface 428 includes a pair of apertures 373 that are provided for threadedly receiving the allen bolts 372 (FIG. 16) for securely engaging at least the second magnets 310, into the second cavity 322.

Additionally, each of the magnets 308, 310 includes a central aperture 434 for receiving fasteners, including a first fastener 321 and a second fastener 325. Fasteners 321, 325 are generally bolt-like as shown in the drawings, but do not have the length of the bolts 321, 325 shown in the drawings. Preferably, when the bolts 321, 325 extend through the central apertures 434, the heads of the first and second bolts 321, 325 are flush with the exterior surface 426 of the respective magnet members 308, 310.

Generally, the central aperture 434 of the first magnet comprises a passthrough passageway to enable the threaded end of the first fastener 438 to engage the threaded aperture 442 that extends inwardly from the bottom planar surface 340 of first cavity 344.

Through this threaded engagement with the first magnet member 308, the magnet member 308 is securely fastened into the first cavity 334. In contrast, the second magnet member 310 is retained in its cavity through the engagement of the allen bolts 372, in the apertures 373 that are disposed on the interior surface 428 of the magnet member. The central aperture 434 of the second magnet member 446 provides a pass through passageway that enables the second bolt 325 to extend there through, so that the threads of the bolt 325 can engage the threaded aperture 332 of the third mold insert member 318.

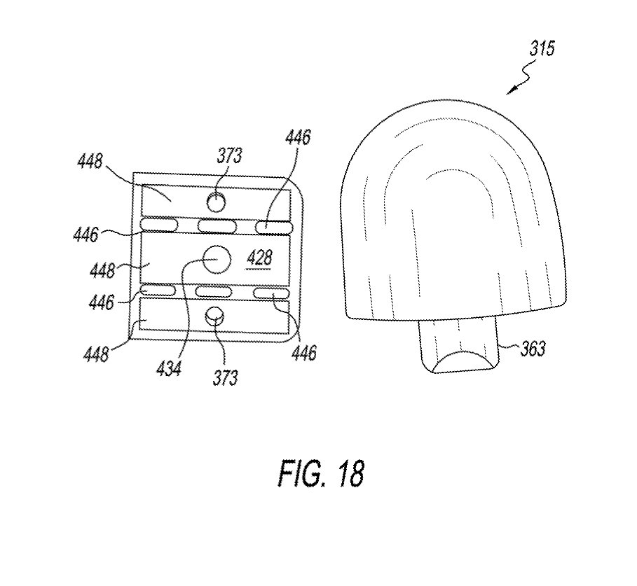

The magnetic circuit 420 as shown in FIG. 18 includes inter-leaf magnets 446 and ferrous metal plates 448 that form a closed magnetic circuit. The magnets 446 are spaced periodically along the length of the ferrous metal plate 448. For example, in the illustrative embodiment, three magnets 446 are employed between each metal plate 448, with each being approximately (0.375 inches) in width that are spaced apart by about 0.25 inches. In contrast, the ferrous magnetic plates 448 extend along the entire length of the magnetic circuit. As will be noted, there are two sets of inter-leafed magnets 446 sandwiched between three ferrous plates 448.

It has been found that the magnet circuit of the type described above, exerts a most commendable holding power and could be produced to serve reliably and cost-effectively.

Having described the invention in detail with reference to certain preferred embodiments, it will be appreciated that the scope and spirit of the invention incorporates modifications, variations and equivalents of the device described herein, and limited only by the claims and their equivalents.

What is claimed is:

1. A mold insert for use in forming a cavity in a structure cast in a form having a magnetically receptive portion, the mold insert comprising
a first mold insert member having a body portion and a first mating member,
a second mold insert member having a body portion and a second mating member, the first and second mating members being engageable to enable the first and second mold insert members be configured in each of a joined configuration and an unjoined configuration, and
at least one magnet member removably engageable to at least one of the first and second mold insert members, the magnet member being configured for magnetically adhering the mold insert to the form.

2. The mold insert of claim 1 wherein the form comprises a form comprised of a ferrous material, and the structure comprises a concrete structure.

3. The mold insert of claim 2 further comprising a coupler member configured to be placeable in each of a joined configuration and unjoined configuration with each of the first and second mold insert members.

4. The mold insert of claim 1 wherein the coupler member, when in a joined configuration with each of the first and second insert members is positioned between the first and second insert members, and defines a passageway extending between the first and second insert members for receiving a molded in member.

5. The mold insert of claim 4 wherein the molded in member comprises an anchor, and wherein the coupler member, first mold insert member and second mold insert member are configured, when in the joined configuration for holding and positioning the anchor member in the form for proper placement in the structure cast in the form.

6. The mold insert of claim 5 wherein the coupler member is configured for creating an aperture in the cast structure disposed interiorly of the anchor member, wherein the first and second insert members are disengageable from the coupler member for permitting the coupler member to be removed from the cavity formed in the cast structure.

7. The mold insert of claim 3 wherein the coupler member includes a third mating member configured for removably mating with the first mating member, and a fourth mating member configured for removably mating with the second mating member.

8. The mold insert of claim 7 wherein one of the first and third mating members comprises a male mating member, and the other of the first and third mating members comprises a female mating member sized and configured for selectively receiving the male mating member for permitting the first insert member to move relative to the coupler member in a linear path in a direction into and out of the cavity of the cast structure.

9. The mold insert of claim 8 wherein the first and second mating members comprise radially extending longitudinal groove female mating members having a truncated triangular cross-section, and wherein the third and fourth mating members comprise radially extending longitudinal tongue male mating members having a truncated triangular cross-section sized and configured for being received in the longitudinal grooves of the first and second mating members.

10. The insert member of claim 1 further comprising a coupler member removably joinable to each of the first and second insert members.

11. The insert member of claim 10 wherein the coupler member is positioned between the first and second insert members, and is movable between a joined configuration where the coupler, first insert member and second insert member define a passageway extending between the first and second insert member for receiving a molded in member that will remain within the cast structure after the mold insert is removed.

12. The mold insert of claim 1 wherein the magnet comprises a magnet member molded into a plastic casing, wherein at least one of the first and second insert members includes a base portion having a magnet receiving cavity sized and configured for receiving the magnet member and plastic casing.

13. A mold insert for use in forming a cavity in a structure cast in a form having a magnetically receptive portion, the mold insert comprising:
a first mold insert member and a second mold insert member,
the first mold insert member including a base portion, a base surface, a second mold insert receiving portion, a body portion extending outwardly from the base portion, and a magnet receiving cavity formed in the base portion,
the second mold insert member including a first mold insert receiving portion for matingly engaging the second mold insert receiving portion of the first mold insert member,
a magnet member sized and configured for being received in the magnet receiving cavity, and
a first coupler accessible from the base surface for removably coupling the second mold insert member to the first mold insert member.

14. The mold insert of claim 13 wherein the body portion of the first mold insert member includes a first cavity defining surface, and the second mold insert member includes a second cavity defining surface disposed in a spaced relation to the first cavity defining surface to define a cavity there between for being sized and configured for receiving a molded in member.

15. The mold insert of claim 14 wherein the second mold insert member includes a laterally extending finger which extends in the cavity between the first and second cavity defining surface for creating an aperture in the cast structure positioned adjacent to the molded in member.

16. The mold insert of claim 15 wherein the cast structure comprises a concrete cast structure, and the molded in member comprises an anchor member molded in the cast structure and configured for being engaged by material handling equipment for facilitating the movement of the cast structure.

17. The mold insert of claim 13 wherein the second mold insert receiving portion includes a stage having a raised portion and the first mold member receiving portion includes a cavity sized and positioned for receiving the stage portion.

18. The mold insert of claim 13 wherein the magnet member comprises a metal magnet encased in a plastic housing, the magnet member including an aperture for receiving the first coupler, wherein the first coupler extends through the magnet member for engaging the second mold insert member.

19. The mold insert of claim 13 wherein the base surface is configured for engaging a surface of the form, and the magnet member includes an exteriorly facing surface sized and configured for being generally coplanar with the base surface for permitting the magnet member to engage a surface of the form.

20. The mold insert of claim 13 wherein the first mold insert member includes a radially extending first cavity defining surface, the second mold insert member includes a radially extending second cavity defining surface disposed in a spaced relation to the first cavity defining surface, the first and second cavity defining surfaces defining a radially extending cavity sized and configured for receiving a molded in member, the first mold insert member including a molded in member receiving portion disposed in the cavity for engaging a surface of the molded in member, the second mold insert including a finger extending between the first and second cavity defining surfaces for engaging the molded in member.
